(19) United States
(12) Patent Application Publication
(10) Pub. No.: US 2021/0030195 A1
(43) Pub. Date: Feb. 4, 2021

(54) Beverage Maker And Method For Operating A Beverage Maker

(71) Applicant: WMF Group GMBH, Geislingen (steige) (DE)

(72) Inventor: Philipp Schirrmacher, Ulm (DE)

(73) Assignee: WMF Group GMBH, Geislingen (steige) (DE)

(21) Appl. No.: 17/044,955

(22) PCT Filed: Mar. 13, 2019
(86) PCT No.: PCT/EP2019/056216

§ 371 Date: Oct. 2, 2020

(30) Foreign Application Priority Data
Apr. 5, 2018 (DE) 10 2018 205 153.4

(51) Int. Cl. A47J 31/52; G05B 19/042

(52) U.S. Cl. CPC A47J 31/525; G05B 2219/2645; G05B 19/042

(57) ABSTRACT

A beverage maker and a method for operating a beverage maker are provided. The beverage maker comprises a sensor of a 1st category which provides only one individual measuring value S1 at a specific time, a sensor of a 2nd category which provides a plurality of measuring values S2 at a specific time, a data memory and a control unit. The control unit is configured to compare the measuring values S2 with target values which are stored in the data memory and, based on this comparison, to trigger or not to trigger at least one event. If the comparison does not lead to an event being triggered, detection of at least one measuring value S1 is effected by the control unit, the measuring value S1 being used to assign the measuring values S2 to at least one event and to store these measuring values S2 as target values for the assigned event in the data memory.

A beverage maker and a method for operating a beverage maker are provided. The beverage maker comprises a sensor of a 1st category which provides only one individual measuring value S1 at a specific time, a sensor of a 2nd category which provides a plurality of measuring values S2 at a specific time, a data memory and a control unit. The control unit is configured to compare the measuring values S2 with target values which are stored in the data memory and, based on this comparison, to trigger or not to trigger at least one event. If the comparison does not lead to an event being triggered, detection of at least one measuring value S1 is effected by the control unit, the measuring value S1 being used to assign the measuring values S2 to at least one event and to store these measuring values S2 as target values for the assigned event in the data memory.

Machines, such as e.g. beverage makers, are mainly designed to accept commands from users and to convert them into a result. The commands (e.g. in the form of entire command chains) are therefore processed by the machine and completed with a result (expected by the user). Complex tasks can no longer be achieved simply in this way by the machine since it is very laborious to detect, to define and to programme the complex tasks with their boundary conditions to form command chains. This process requires a lot of time, has a certain risk of failure and is associated with high costs.

There is understood, in general language use, by the term “artificial intelligence”, with respect to a computer, that the computer is constructed or programmed such that it can solve problems autonomously. In the formation of an artificial, neuronal network, it concerns forming a network of nodes and connections on a software plane. The network is developed in the software by connections or nodes being deleted, added or otherwise weighted.

Machine learning is based on algorithms and codes. In the case of machine learning, data are acquired by the machine, learning takes place from the data and corresponding decisions are made. The algorithm of the machine learning can be represented as a flow chart or decision tree. The individual branches of the flow chart or decision tree are weighted by the data collected by the machine.

Monitored learning of a machine is directed to a task to be learned which is established in advance, the results of which are known (state of 22.03.2018: https://de.wikipedia.org/wiki/% C3%9Cberwachtes_Lernen). The results of the learning process can be compared with the known, correct results, i.e. are “monitored”. Generally a learning step looks like the following:
1. applying the input;
2. processing the input (propagation);
3. comparing the output with the desired value (error);
4. reducing the error by modification of the weighting (e.g. with backpropagation).

In the case of unmonitored learning of a machine, no target values are known in advance. The machine attempts to detect patterns and to interpret these.

In the case of backpropagation (“backpropagation”=error feedback), the algorithm runs in the following phases (state of 22.03.2018: https://de.wikipedia.org/wiki/Backpropagation):
1. An input pattern is applied and propagated forwards through the network;
2. The output of the network is compared with the desired output and the difference of the two values is regarded as error of the network; and
3. The error is now propagated back again via the output- to the input layer, the weightings of the connections in the network changing as a function of their influence on the error. This guarantees, in the case of renewed application of the input, an approximation to the desired output.

A branch of the machine learning is termed deep learning (“deep learning”). Huge quantities of data are hereby analysed and patterns are detected and derived therefrom.

Artificial intelligence is advantageous above all if a machine is intended to implement a specific process from a complex detection pattern of a sensor (e.g. an accumulation of a plurality of measuring points instead of from a single measuring value).

Sensors can basically be divided into two different categories, namely sensors of the 1st category and sensors of the 2nd category.

Sensors of the 1st category provide merely one individual measuring value at a specific time, such as e.g. a specific temperature (temperature sensor), a specific pressure (pressure sensor), a specific speed (speed sensor), a specific flow rate (flow rate sensor) or a specific electrical capacitance. If this category of sensors measures permanently, then individual measuring values are obtained as a function of the time. The result of the measurement can be illustrated in an x-y diagram, x representing the time and y the individual measuring value. A touch screen of a beverage maker may be mentioned here as example which, upon exceeding a specific pressure (pressure-sensitive touch screen) or upon detection of a specific capacitance (capacitive touch screen) on a specific field of the touch screen, effects a specific event, such as e.g. the output of a specific drink.

Sensors of the 2nd category provide, at a specific time, not only an individual, but at least two different measuring values, such as e.g. the frequency and the amplitude of a longitudinal oscillation (e.g. acoustic sensor or oscillation sensor), the frequency and the amplitude of a transverse oscillation (e.g. light sensor, IR sensor or radar sensor), a direction and a strength of a magnetic field (magnetic field sensor) or the electrical conductivity, the pH value and the sugar concentration of a specific liquid (taste sensor). If this category of sensors measures permanently, then at least two different measuring values are obtained as a function of the time. The result of the measurement can be illustrated in an x-y-z diagram in the case of two different measuring values, x representing the time, y the first measuring value and z the second measuring value.

Electrical appliances (e.g. beverage makers such as coffee machines) preferably operate with sensors of the 1st category since, with these sensors, the measuring values to be determined are available without great computing complexity. For example, a resistance-based temperature sensor outputs a specific resistance at a specific time and, from this specific resistance, a conclusion is drawn about a specific temperature.

The electrical appliances includes a software which can prescribe how the appliance should react upon measurement of a specific measuring value at a specific time. For example, upon exceeding a specific threshold value, an action of the appliance can be triggered. In general terms, the software stores a table in which measuring values are assigned to a specific appliance state or to a specific action of the appliance (i.e. to a specific control command of the appliance). In this way, the appliance itself can be controlled via a single measuring value of a sensor, e.g. a specific action can be implemented.

Electrical appliances can basically be controlled also with sensors of the 2nd category. In this case also, tables or patterns can be applied in which an assignment of specific measuring values (patterns) detected by the sensor is encoded to form one or more actions of the machine. However for producing the assignment(s), the complexity is significantly higher than in the case of the (simpler) sensors of the 1st category. The reason for the higher complexity is that, for the command to the appliance to implement a specific action, at least two measuring values must assume respectively a specific prescribed value (“and” operation of y value and z value at the time x) and hence the complexity of the control increases.

It is assumed that the increasing requirements on electrical appliances (in particular: beverage makers such as coffee machines), i.e. complex control processes in electrical appliances, can be fulfilled in the future only with sensors of the 2nd category.

It is therefore the object of the present invention to provide a beverage maker which can learn and implement complex control processes in a simple manner and with minimal complexity for a user.

The invention is achieved by a beverage maker having the features of claim 1 and a method having the features of claim 8. The independent claims show advantageous developments.

According to the invention, a beverage maker is provided, comprising
a) at least one sensor of a 1st category, there being understood by a sensor of the 1st category a sensor which provides only one individual measuring value S1 at a specific time;
b) at least one sensor of a 2nd category, there being understood by a sensor of the 2nd category a sensor which provides a plurality of measuring values S2 at a specific time;
c) a data memory; and
d) a control unit, the control unit being configured to compare the measuring values S2 with target values for the measuring values S2 which are stored in the data memory and encode for at least one specific event and, based on this comparison, to trigger or not to trigger at least one event in the beverage maker;

characterised in that the control unit of the beverage maker is configured furthermore to detect and to use at least one measuring value S1 in order to assign specific measuring values S2, which do not trigger an event after a comparison with target values for the measuring values S2, to at least one event, and to store these measuring values S2 as target values for the at least one event in the data memory.

The beverage maker according to the invention is hence suitable for teaching one or more sensor(s), contained in the beverage maker, of the 2nd category by means of one or more sensor(s), contained in the beverage maker, of the 1st category about specific, regularly occurring events. An event is hereby for example an output of espresso by the beverage maker which is confirmed by a user via the at least one sensor of the 1st category if the at least one sensor of the 2nd category detects an espresso cup at a specific place of the beverage maker (e.g. under a brewing group). Confirmation of the user can hereby be effected by means of pressure on a button which can be implemented quickly and easily. Storage of the measuring values S2 for this event is effected automatically in the data memory.

The advantage of “teaching” the beverage maker via at least one sensor of the 1st category is that the complexity of the teaching is very low for the user of the beverage maker (e.g. implementing a simple press of a button).

If after learning, an espresso cup is again placed in the detection region of the at least one sensor of the 2nd category, the comparison, implemented by the control unit of the beverage maker, of the pattern detected by the sensor of the 2nd category with the pattern stored in the data memory has the effect that the learned event is triggered automatically by the beverage maker (i.e. without further input of a user). The learned, automatically triggered event can concern for example the display of a “yes/no” enquiry about a specific drink (e.g. espresso), the display of a timer until output of a specific drink (e.g. espresso), the display or highlighting of a specific selection of beverage (e.g. espresso, ristretto, espresso macchiato) and/or the immediate output of an espresso. If the learned event concerns the immediate output of an espresso by the beverage maker, then an espresso is automatically output therefore by the beverage maker. In other words, a renewed confirmation, or selection, of the output of espresso by a user is no longer necessary. If the learned event concerns the display or highlighting of a specific selection of beverage, then the specific selection of beverage is displayed or highlighted automatically by the beverage maker. A specific drink can then be selected in this selection by the user. Selection can be effected via a sensor of the 1st category, for example via pressure on a button of the beverage maker or touching a field on a touch screen of the beverage maker, or by a sensor of the 2nd category, for example via implementing a gesture and/or facial expression (e.g. eye control) in front of a camera of the beverage maker.

The beverage maker according to the invention therefore assigns measuring values of sensors of the 2nd category, based on a confirmation via a sensor of the 1st category, to events specified by a user, stores this assignment in its data memory and reacts in the future correspondingly, if an already effected (known) event occurs again. This assignment is effected according to the principle of machine learning.

With increasing frequency of events during operation of the beverage maker, the wealth of experience of the beverage maker increases. Therefore by the beverage maker being faced with many events, the probability increases that a specific detection pattern is already known on the sensor of the 2nd category and hence also triggers an event without activation of a sensor of the 1st category. In other words, the association between the patterns detected by the sensor of the 2nd category and the associated events is increased. Correspondingly, the significance of the sensors of the 1st category reduces increasingly and no longer plays any role in the ideal case of a “taught” beverage maker. The triggered event can also be that e.g. an operating surface of the beverage maker is displayed in a specific form, i.e. differently from before triggering of the event. A specific beverage selection can hereby be displayed or highlighted on the operating surface. The selection of a specific drink in this beverage selection can be effected for example by pressure on a button (sensor of the 1st category) or by a specific gesture (sensor of the 2nd category).

In a preferred embodiment, the beverage maker according to the invention includes a user interface, preferably in the form of a touch screen. The user interface can be configured to display a triggered event. Furthermore, the user interface can be configured to display a countdown until implementation of a triggered event. In addition, the user interface can be configured to display a (specific) beverage selection. Furthermore, the user interface can be configured to display information about measuring values S2 of the at least one sensor of a 2nd category, preferably information selected from the group consisting of height of a beverage container, level of a beverage container, level of a bean container of the beverage maker, empty running of a grinder of the beverage maker and combinations hereof. Furthermore, the user interface can be configured to display target values for S2 and also to confirm and/or to delete as a user wishes.

The control unit of the beverage maker can be configured to trigger the at least one event which is encoded in the target values for the measuring values S2 of the sensor of the 2nd category if the measuring values S2 can be assigned to target values for the measuring values S2 with a probability of respectively >50%, preferably ≥60%, particularly preferably ≥70%, very particularly preferably ≥80%, in particular ≥90%.

In a preferred embodiment, the control unit of the beverage maker is configured to use at least one measuring value S1 if the measuring values S2 can be assigned to target values for the measuring values S2 with a probability of respectively only ≥50%, preferably ≥40%, particularly preferably ≥30%, very particularly preferably ≥20%, in particular ≥10%.

The at least one sensor of the 1st category can be configured to provide one only one-dimensional measuring value S1 at a specific time. The one-dimensional measuring value can be selected from the group consisting of temperature, pressure, speed, flow rate, electrical capacitance, movement direction, distance, time and mass.

The at least one sensor of the 1st category can be selected from the group consisting of temperature sensor, pressure sensor, speed sensor, flow rate sensor, sensor for electrical current and capacitive sensor. Preferably the at least one sensor of the 1st category is a pressure sensor and/or capacitive sensor. Very particularly preferably, the sensor of the 1st category is a touch screen of the beverage maker.

The at least one sensor of the 2nd category can be configured to provide multidimensional measuring values S2 at a specific time, preferably at least three-dimensional measuring values S2, particularly preferably at least four-dimensional measuring values S2. A dimension of the multidimensional measuring value S2 can be selected from the group consisting of frequency of an oscillation (e.g. wavelength of light, i.e. light colour), amplitude of an oscillation (e.g. amplitude of light, i.e. light intensity), polarisation of an oscillation (e.g. polarisation of light), propagation direction of an oscillation (e.g. propagation direction of light), propagation direction of force lines (e.g. propagation direction of magnetic field lines), strength of force lines (e.g. strength of magnetic field lines). A further dimension of the multidimensional measuring value S2 can likewise be selected from the above-mentioned group, the further dimension then being different from the (first) dimension.

The at least one sensor of the 2nd category can be selected from the group consisting of sensors for detecting longitudinal oscillations, sensors for detecting transverse oscillations, sensors for detecting magnetic fields, sensors for detecting electrical fields, chemical sensors, electrical sensors and combinations hereof. Preferably, the sensor of the 2nd category is selected from the group consisting of sound sensor, vibration sensor, light sensor (e.g. a camera), IR sensor, radar sensor, magnetic field sensor, conductivity sensor, pH sensor, sensor for detecting a sugar concentration and combinations hereof. Preferably the sensor of the 2nd category concerns a radar sensor, a light sensor (e.g. a line camera or matrix camera), a sound sensor (e.g. an acoustic sensor) and combinations hereof.

Radar sensors are particularly preferred sensors of the 2nd category. They have the advantage that they provide very precise information about the nature of specific beverage containers and hence enable a fine and precise differentiation of different beverage containers.

Light sensors, such as line cameras or matrix cameras, are likewise particularly preferred sensors of the 2nd category. They provide, over a time x in the matrix y/z a value y and a value z, the value y concerning for example a specific light intensity (light brightness) and the value z for example a specific light frequency (light colour). In the case of ToF sensors, a spatial distance relative to the sensor can be detected as additional dimension. Light sensors, such as radar sensors, are suitable for providing information about the nature of specific beverage containers.

Sound sensors (such as e.g. acoustic sensors) are also particularly preferred sensors of the 2nd category. Sound sensors are suitable for example for detecting grinding noises of a grinder (e.g. for coffee beans) of the beverage maker and preventing empty running of the grinder. For this function, the sound sensor is preferably fitted in the vicinity of a grinder of the beverage maker. The advantage of use of such a sound sensor as sensor of the 2nd category is that, via the sound curve recorded by this sensor, a sound pattern can be used shortly before empty running of the grinder to display impending empty running of the grinder to the user. By predicting the impending empty running of the grinder, a user can be prompted to refill a bean container and hence the bean container can be prevented from emptying during dispensing of a drink (e.g. coffee). This has the effect that providing a drink (e.g. coffee) can be implemented without interruption and there is no outage time in the beverage maker. Furthermore, the problem is known that a grinder once run empty requires a certain lead time (a certain grinding time) in order to fill again with (ground) beans after the bean container has been filled. This extends, on the one hand, the time until provision of a drink after triggering dispensing of a drink. On the other hand, the result is metering variations relative to the quantity of ground beans which are used to prepare the drink and hence to a certain variability in the composition of the dispensed drink after empty running of the grinder. Use of the sound sensor has the effect that empty running of the grinder can be prevented from the start. Consequently a drink can always be provided with a uniform product composition by the beverage maker without outage times and without delays during dispensing.

In a preferred embodiment, the at least one specific event (which can be triggered within the beverage maker) is selected from the group consisting of
i) interaction of the beverage maker with a user, preferably selected from the group consisting of outputting a request of the beverage maker to the user, displaying a specific beverage selection, fading out a specific beverage selection and combinations hereof, the request being selected particularly preferably from the group consisting of refilling coffee beans, emptying salt container, filling water tank, filling milk tank, starting a care program (e.g. start of a cleaning program, start of a descaling program and/or start of a washing program) and combinations hereof;
ii) maintaining the beverage maker, preferably selected from the group consisting of detecting and/or evaluating faults in the running of the beverage maker, detecting and/or evaluating faults in components of the beverage maker, determining a service interval of the beverage maker, triggering a service call of the beverage maker, setting and/or adapting an adjustment of the beverage maker;
iii) controlling at least one component of the beverage maker, preferably outputting a specific drink via the beverage maker, moving a beverage outlet of the beverage maker, implementing a care program of the beverage maker and combinations hereof; and
iv) combinations hereof.

Furthermore, a method for operating a beverage maker is provided according to the invention, comprising the steps
a) detecting a plurality of measuring values S2 from at least one sensor of a 2nd category, there being understood by a sensor of the 2nd category a sensor which provides a plurality of measuring values S2 at a specific time;
b) comparing the measuring values S2 with target values for the measuring values S2, which are stored in a data memory of the beverage maker and encode for at least one specific event, by a control unit of the beverage maker;
c) triggering or not triggering at least one event in the beverage maker based on this comparison; and
d) detecting at least one measuring value S1 from at least one sensor of a 1st category if no event is triggered, there being understood by a sensor of the 1st category a sensor which provides only one individual measuring value S1 at a specific time;

characterised in that, in the case in which no event is triggered after the comparison with target values for the measuring values S2, at least one measuring value S1 from at least one sensor of a 1st category of the beverage maker is used by the control unit in order to assign at least one event to the measuring values S2 which do not trigger an event after a comparison with target values for the measuring values S2, and these measuring values S2 are stored as target values for the at least one event in the data memory.

The beverage maker used in the method according to the invention can include a user interface, preferably a touch screen. Preferably a triggered event is displayed via the user interface. Furthermore, a countdown until implementation of a triggered event can be displayed via the user interface. In addition, via the user interface, a (specific) beverage selection can be displayed. Furthermore, information about measuring values S2 of the at least one sensor of a 2nd category can be displayed via the user interface, preferably information selected from the group consisting of height of a beverage container, level of a beverage container, level of a bean container of the beverage maker, empty running of a grinder of the beverage maker and combinations hereof. Furthermore, target values for S2 can be displayed via the user interface and can be confirmed and/or deleted according to the wishes of a user.

In a preferred embodiment, the at least one event which is encoded in the target values for the measuring values S2 is triggered if the measuring values S2 can be assigned to target values for the measuring values S2 with a probability of respectively >50%, preferably ≥60%, particularly preferably ≥70%, very particularly preferably ≥80%, in particular ≥90%.

In the method according to the invention, for example the at least one measuring value S1 can be detected and used if the measuring values S2 can be assigned to target values for the measuring values S2 with a probability of respectively only ≤50%, preferably ≤40%, particularly preferably ≤30%, very particularly preferably ≤20%, in particular ≤10%.

In a preferred embodiment of the method, the at least one sensor of the 1st category provides one one-dimensional measuring value S1 at a specific time. The one-dimensional measuring value can be selected from the group consisting of temperature, pressure, speed, flow rate, electrical capacitance, movement direction, distance, time and mass.

The sensor of the 1st category used in the method can have the same properties as the above-described sensor of the 1st category of the beverage maker.

Furthermore, it is preferred if, in the method, at least one sensor of the 2nd category is used, which sensor provides multidimensional measuring values S2 at a specific time, preferably at least three-dimensional measuring values S2, in particular at least four-dimensional measuring values S2. A dimension of the multidimensional measuring value can be selected from the group consisting of frequency of an oscillation (e.g. wavelength of light, i.e. light colour), amplitude of an oscillation (e.g. amplitude of light, i.e. light intensity), polarisation of an oscillation (e.g. polarisation of light), propagation direction of an oscillation (e.g. propagation direction of light), propagation direction of force lines (e.g. propagation direction of magnetic field lines), strength of force lines (e.g. strength of magnetic field lines). A further dimension of the multidimensional measuring value can likewise be selected from the above-mentioned group.

The sensor of the 2nd category used in the method can have the same properties as the above-described sensor of the 2nd category of the beverage maker.

The method can be characterised in that the at least one specific event is selected from the group consisting of
i) interaction of the beverage maker with a user, preferably selected from the group consisting of outputting a request of the beverage maker to the user, displaying a specific beverage selection, fading out a specific beverage selection and combinations hereof, the request being selected particularly preferably from the group consisting of refilling coffee beans, emptying salt container, filling water tank, filling milk tank, starting a care program and combinations hereof;
ii) maintaining the beverage maker, preferably selected from the group consisting of detecting and/or evaluating faults in the running of the beverage maker, detecting and/or evaluating faults in components of the beverage maker, determining a service interval of the beverage maker, triggering a service call of the beverage maker, setting and/or adapting an adjustment of the beverage maker;
iii) controlling at least one component of the beverage maker, preferably outputting a specific drink via the beverage maker, moving a beverage outlet of the beverage maker, implementing a care program of the beverage maker and combinations hereof; and
iv) combinations hereof.

With reference to the following Figures and examples, the subject according to the invention is intended to be explained in more detail without wishing to restrict the latter to the specific embodiments represented here.

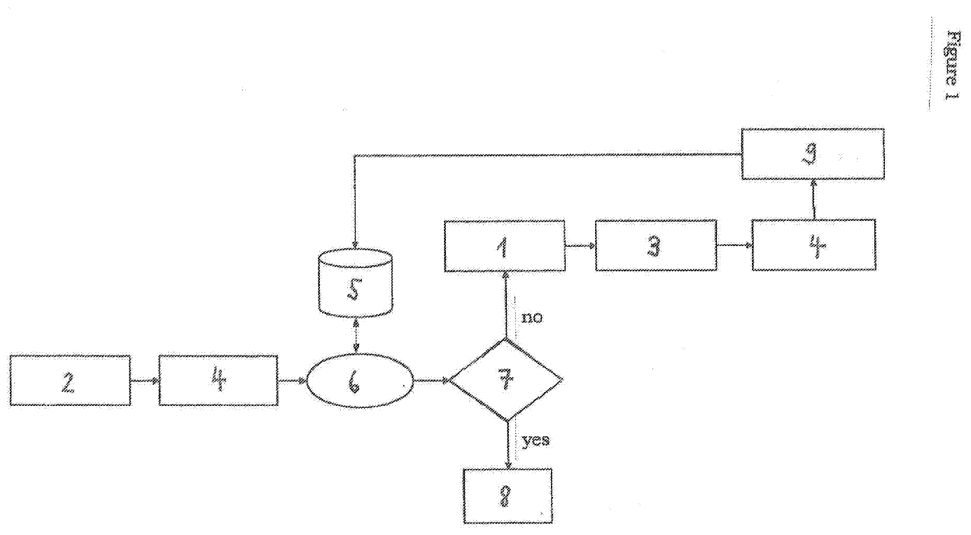

FIG. 1 shows the functional mechanism of a beverage maker according to the invention. If an object to be analysed is detected by the sensor of the 2nd category 2, a plurality of measuring values 4 (a so-called pattern) is transmitted from the sensor of the 2nd category 2 to the control unit 6 of the beverage maker. The control unit 6 accesses the data memory 5 and checks whether the detected measuring values 4 are already known with a specific probability, i.e. whether these are stored in the data memory 5 and assigned there to a specific event. If this question 7 can be answered in the affirmative, the beverage maker triggers a specific event 8. If this question is not answered in the affirmative, the beverage maker waits for an individual measuring value 3 of the sensor of the 1st category 1. After obtaining the measuring value 3 of the sensor of the 1st category 1, an assignment of the measuring values 4 detected by the sensor of the 2nd category 2 to at least one specific event 8 in the beverage maker is effected. In the data memory 5, originally no pattern 4 is associated with an event 8. A measuring value 3 of the sensor of the 1st category is then used for the purpose of associating, with the measured two measuring values 4 of the sensor of the 2nd category, a specific event 8 and storing this association in the data memory 5 (=machine learning).

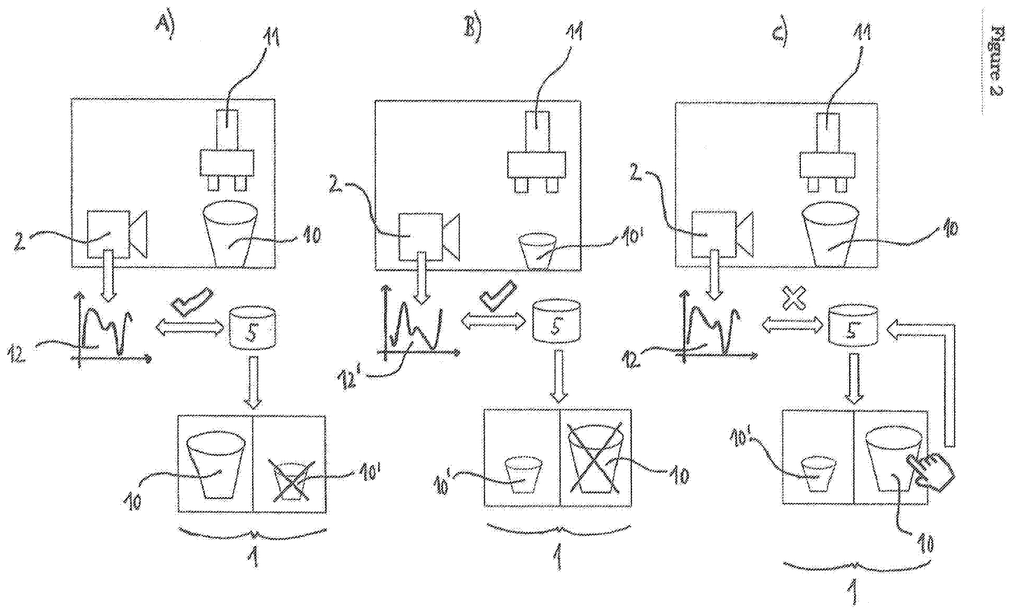

FIG. 2 shows the functional mechanism of a beverage maker according to the invention with a radar sensor 2 for detecting a plurality of measuring values 12, 12′ of a vessel 10, 10′ which is placed by a user under a beverage output unit 11 of the beverage maker.

In FIG. 2A, the vessel is a latte-macchiato glass 10 which produces a frequency spectrum 12, which is characteristic of this glass 10, from the radar sensor 2. In the case of FIG. 2A, this characteristic frequency spectrum 12 is already stored in the data memory 5 of the beverage maker (see √ symbol) so that the beverage maker recognises the latte-macchiato glass 10 as such and, without further input of the user (e.g. via an interaction with a sensor of the 1st category 1), implements an event associated with this glass 10 (e.g. output of a latte-macchiato via the beverage output unit 11 of the beverage maker or displaying or highlighting a specific beverage selection). If the event is displaying or highlighting of a specific beverage selection (e.g. an enlarged display of specific beverage on a user surface of the beverage maker), then, with pressure on a button (activation of a sensor of the 1st category) or a gesture, or facial expression or acoustic speech (activation of a sensor of the 2nd category), a selection and output of a specific drink from the beverage selection can be effected concretely by the user.

The same applies for the situation illustrated in FIG. 2B. In FIG. 2B, instead of the latte-macchiato glass 10, an espresso cup 10′ is placed under the beverage output unit 11 of the beverage maker. Since the characteristic frequency spectrum 12′, detected by the radar sensor 2 for the espresso cup 10′, is already stored in the data memory 5 (see √ symbol), the beverage maker recognises the espresso cup 10′ as such and, without further input of the user (e.g. via an interaction with a sensor of the 1st category 1), implements an event associated with this cup 10′ (e.g. output of an espresso via the beverage output unit 11 of the beverage maker).

In FIG. 2C, a situation is in contrast illustrated in which the pattern 12 detected by the radar sensor 2 for the latte-macchiato glass 10 is not yet stored in the data memory 5 of the beverage maker or has no similarity with patterns stored there (see X symbol). This has the effect that the beverage maker uses a measuring value (here: an impedance change which is changed by a user touching a latter-macchiato glass 10 displayed on the touch screen), which is detected by the sensor of the 1st category 1 (here: a touch screen 1 on the beverage maker) to assign the detected pattern 12 to the event “output of latte-macchiato” and to store this assignment in the data memory 5.

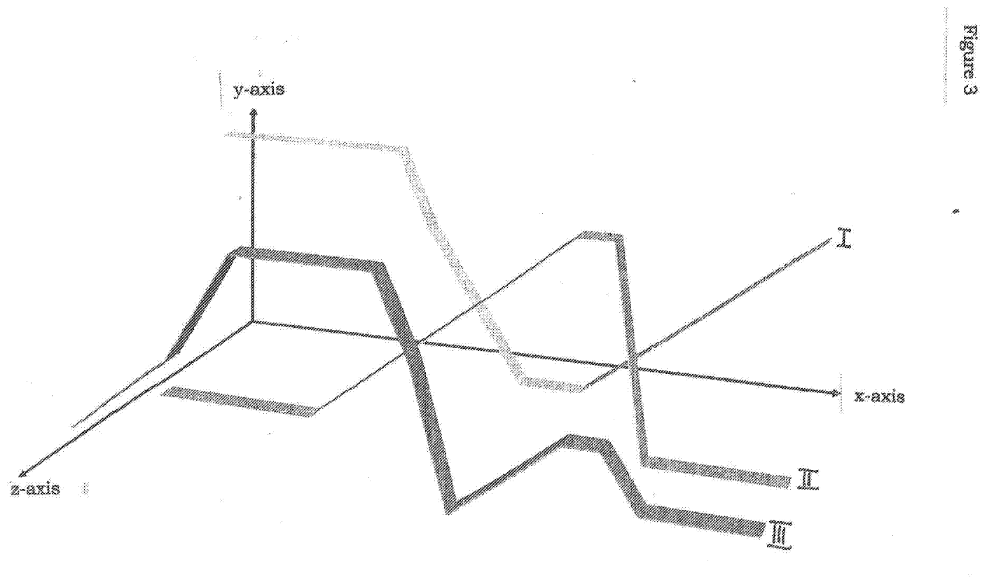

FIG. 3 shows an example of a plurality of measuring values of the sensor of the 2nd category. This sensor of the 2nd category concerns a two-dimensional sensor which, in the course of time (x axis), detects the intensity (y axis=1st dimension) of electromagnetic radiation of a different frequency I, II, III (z axis=2nd dimension).

### Example 1—Beverage Maker with Electromagnetic Sensor for Cup Recognition

The beverage maker is a coffee machine in which a sensor of the 2nd category is incorporated. This sensor here concerns a radar sensor (e.g. a radar sensor with 60 Ghz of Infineon Technologies AG, sensitivity: sub-mm range) or an image sensor.

Firstly a glass or a cup is placed under the beverage maker. In the case of a radar sensor, a frequency of the detected radar radiation is measured as first measuring value and, as second measuring value, an amplitude of the detected radar radiation. In the case of an image sensor, a frequency of the detected light (colour of the light) and an amplitude of the detected light (brightness of the light) is detected.

Since no target values are prescribed in the permanent memory of the beverage maker, also no assignment of the measuring values (i.e. of the pattern) to a specific event is present.

This beverage maker has, as sensor of the 1st category, a user input interface, e.g. a touch pad. Via the user input interface, various beverage which can be output by the beverage maker are displayed to the user.

If the user has placed a latte-macchiato glass under the beverage maker since he wants to have a latte-macchiato made, the user now selects the output of latte-macchiato via pressure on the touch pad. The signal of the sensor of the 1st category (touch pad) is now used in order to associate the signal recorded via the radar sensor or the image sensor with the output of latte-macchiato and to store this association in the permanent data memory. If the same latte-macchiato glass is placed under the beverage maker the next time, the output of latte-macchiato is effected without activation via the touch pad since the beverage maker has assigned the pattern, detected via the sensor of the 2nd category, of the specific latte-macchiato glass to the output of latte-macchiato.

Since the shape of latte-macchiato glasses can vary within a series or between different manufacturers, the allocation becomes all the better the more often a latte-macchiato glass is placed under the beverage maker (increase in shape information). Also with repeated use of a specific glass, the accuracy increases since the sensors of the 2nd category can also have measuring errors, the significance of which reduces with each further repetition of the measurement. At some time or another, a user input via the touch pad is no longer necessary since the machine assigns the detected measuring values unequivocally to a latte-macchiato glass. On the user surface of the beverage maker (e.g. display or touch screen), as a result only the drink can be displayed which, on the basis of comparison with the data memory, has matched the last outputs with the same pattern S2 and the appropriate push of the button of S1 (here: a latte-macchiato). The user then has the choice of selecting the drink (here: only a latte-macchiato displayed on the user surface) or possibly cancelling it with another command.

Of course, the control unit of the beverage maker can be configured such that the beverage maker, after the vessel has been put down, offers the user a beverage selection and/or blocks specific beverage. If no alternative beverage are available for a latte-macchiato glass, the control unit can be configured such that the output of latte-macchiato is started automatically. This can for example be effected via a display “drink is automatically started in X seconds. To cancel press Y”, X standing for seconds and Y for a button to be pressed on the beverage maker.

For example, the radar sensor functions as sensor of the 2nd category such that a part of the radar waves is reflected on the surface of the object to be checked (e.g. a coffee cup) and another part penetrates before the reflection into the object, slows down due to the higher density of the object compared with the ambient air, and then emerges again from the object. The quantity of reflected beams and the running time differences between the reflecting beams and the emitting beams is characteristic of different objects and materials.

Furthermore, further information about the glass or the cup can be collected via additional sensors in the beverage maker and can be assigned to the sensor signals. The following sensors are possible:
collision detection sensor for determining the height of the vessel;
flow sensor for protecting against overflow of the vessel;
pressure sensor for cancelling dispensing of the drink in order to adapt the volume quantity to the normal use of the user.

### Example 2—Beverage Maker with Acoustic Sensor for an Beans-Empty Report

This beverage maker is a coffee machine and includes an acoustic sensor as sensor of the 2nd category. The acoustic sensor “hears” various events or errors. For example, the grinder of a coffee machine emits a characteristic noise when running empty. This noise can be recorded by the acoustic sensor and associated with the event that the grinder should stop the grinding process. If the acoustic sensor again detects the characteristic noise after this “learning process”, the grinder can be stopped before the result is complete empty running of the grinder.

In the state of the art, for example only one current sensor provides information about whether a grinder motor is running empty, i.e. no longer grinding coffee beans. In this case, the level of the electrical current detected by the current sensor drops. Now the noise pattern emitted by the grinder can be detected and learned for example in fact 2 to 3 seconds before reaching the current boundary value. By this measure, the beverage maker detects a state shortly before “becoming empty” of the grinder and can switch off the grinder in good time (before detecting the lower current value). The advantage hereby is that a product preparation is not interrupted by refilling with beans: when the grinder is running empty, grinder and grinder outflow are empty and, after filling with coffee beans, a specific lead time (grinding time) is required in order to fill the system with beans and ground coffee. Only thereafter are coffee grounds again conveyed correctly in the brewing chamber. Consequently a time loss is produced and the result is metering variations with respect to the ground coffee grounds.

Also the noise during refilling of beans could be detected and a specific event associated with this process.

### REFERENCE NUMBER LIST

1: sensor of the 1st category (e.g. touch display);
2: sensor of the 2nd category (e.g. radar sensor);
3: individual measuring value S1 of the sensor of the 1st category (e.g. a discrete pressure value of a pressure sensor);
4: a plurality of measuring values S2 of the sensor of the 2nd category (e.g. with locally resolved discrete frequencies and discrete intensities of an electromagnetic radiation);
5: data memory;
6: control unit;
7: determining whether measuring values 4 are present in the data memory 5;
8: event which is triggered by the beverage maker;
9: assignment of measuring values 4 to at least one event;
10: latte-macchiato glass;
10′: espresso cup;
11: beverage output unit of the beverage maker;
12: frequency spectrum of a latte-macchiato glass 10;
12′: frequency spectrum of an espresso cup 10′;
I: 1st frequency of electromagnetic radiation;
II: 1st frequency of electromagnetic radiation;
III: 3rd frequency of electromagnetic radiation;

1. A beverage maker comprising:
a) at least one sensor of a first category, the sensor of the first category configured to provide only one individual measuring value S1 at a specific time;
b) at least one sensor of a second category, the sensor of the second category configured to provide a plurality of measuring values S2 at a specific time;
c) a data memory;
d) a control unit configured to compare the measuring values S2 with target values for the measuring values S2, the target values stored in the data memory and encoded for at least one specific event and, based on the comparison, to trigger or not to trigger at least one event in the beverage maker;
wherein the control unit is further configured to detect and to use at least one measuring value S1 in order to assign specific measuring values S2, which do not trigger an event after a comparison with target values for the measuring values S2, to at least one event, and to store the specific measuring values S2 as target values for the at least one event in the data memory.

2. The beverage maker according to claim 1, further comprising a user interface, the user interface configured
i) to display a triggered event; and/or
ii) to display a countdown until implementation of a triggered event; and/or
iii) to display a beverage selection;
iv) to display information about measuring values S2 of the at least one sensor of the second category, the information selected from the group consisting of height of a beverage container, level of a beverage container, level of a bean container of the beverage maker, empty running of a grinder of the beverage maker and combinations hereof; and/or
v) to display target values for S2 and to confirm and/or to delete as a user wishes.

3. The beverage maker according to claim 1, wherein the control unit is configured to trigger the at least one event encoded in the target values for the measuring values S2 if the measuring values S2 can be assigned to target values for the measuring values S2 with a probability >50%.

4. The beverage maker according to claim 1, wherein the control unit is configured to use at least one measuring value S1 if the measuring values S2 can be assigned to target values for the measuring values S2 with a probability only ≤50%.

5. The beverage maker according to claim 1, wherein the at least one sensor of the first category is configured to provide one only one-dimensional measuring value S1 at a specific time.

6. The beverage maker according to claim 1, wherein the at least one sensor of the second category is configured to provide multidimensional measuring values S2 at a specific time.

7. The beverage maker according to claim 1, wherein the at least one specific event is selected from the group consisting of interaction of the beverage maker with a user, maintaining the beverage maker, controlling at least one component of the beverage maker and combinations hereof.

8. A method for operating a beverage maker, comprising:
a) detecting a plurality of measuring values S2 from at least one sensor of a second category, the sensor of the second category configured to provide a plurality of measuring values S2 at a specific time;
b) comparing the measuring values S2 with target values for the measuring values S2, the target values stored in a data memory of the beverage maker and encoded for at least one specific event, by a control unit of the beverage maker;
c) triggering or not triggering at least one event in the beverage maker based on the comparison; and
d) detecting at least one measuring value S1 from at least one sensor of the first category if no event is triggered, the sensor of the first category configured to provide only one individual measuring value S1 at a specific time;
wherein, in a case in which no event is triggered after the comparison with target values for the measuring values S2, at least one measuring value S1 from at least one sensor of a first category of the beverage maker is used by the control unit in order to assign at least one event to the measuring values S2 which do not trigger an event after a comparison with target values for the measuring values S2, and the measuring values S2 are stored as target values for the at least one event in the data memory.

9. The method according to claim 8, wherein the beverage maker includes a user interface, via the user interface
i) a triggered event being displayed; and/or
ii) a countdown until implementation of a triggered event being displayed; and/or
iii) a beverage selection being displayed;
iv) information about measuring values S2 of the at least one sensor of the second category being displayed, the information selected from the group consisting of height of a beverage container, level of a beverage container, level of a bean container of the beverage maker, empty running of a grinder of the beverage maker and combinations hereof; and/or
v) target values for S2 being displayed and being confirmed and/or deleted as a user wishes.

10. The method according to claim 8, wherein the at least one event which is encoded in the target values for the measuring values S2 is triggered if the measuring values S2 can be assigned to target values for the measuring values S2 with a probability of respectively >50%.

11. The method according to claim 8, wherein at least one measuring value S1 is detected and used if the measuring values S2 can be assigned to target values for the measuring values S2 with a probability of respectively only ≤50%.

12. The method according to one of the claim 8, wherein the at least one sensor of the first category provides one one-dimensional measuring value S1 at a specific time.

13. The method according to one of the claim 8, wherein the at least one sensor of the second category provides multidimensional measuring values S2 at a specific time.

14. The method according to claim 8, wherein the at least one specific event is selected from the group consisting of interaction of the beverage maker with a user, maintaining the beverage maker, controlling at least one component of the beverage maker and combinations hereof.
